(19) United States
(12) Patent Application Publication
(10) Pub. No.: US 2025/0392035 A1
(43) Pub. Date: Dec. 25, 2025

(54) BASE STATION ANTENNA, RADIATING ELEMENT AND PHASE SHIFTER ASSEMBLY

(71) Applicant: Outdoor Wireless Networks LLC, Richardson, TX (US)

(72) Inventors: Cheng Xue, Suzhou (CN); YueMin Li, Suzhou (CN); Changfu Chen, Suzhou (CN); Bingyang Li, Suzhou (CN); Jian Zhang, Suzhou (CN); Bin Sun, Suzhou (CN); Pengfei Guo, Suzhou (CN)

(21) Appl. No.: 19/177,779

(22) Filed: Apr. 14, 2025

(30) Foreign Application Priority Data
Apr. 22, 2024 (CN) 2024104869787

(51) Int. Cl. H01Q 1/24; H01P 1/18; H01Q 1/50; H01Q 3/36; H01Q 9/16

(52) U.S. Cl. CPC H01Q 1/246; H01P 1/18; H01Q 1/50; H01Q 3/36; H01Q 9/16

(57) ABSTRACT

A base station antenna comprises a radiating element that includes a feed stalk and a radiator mounted on the feed stalk; a phase shifter assembly that includes a phase shifter cavity that has holes corresponding to a location of the feed stalk on a wall proximate the feed stalk; and a phase shift circuit mounted within the phase shifter cavity, where the feed stalk is fixed relative to the phase shift circuit and a first conductor feature of the feed stalk is directly electrically connected to a second conductor feature of the phase shift circuit by passing through the through holes.

### CROSS-REFERENCE TO RELATED APPLICATION

The present application claims priority to Chinese Patent Application No. 202410486978.7, filed Apr. 22, 2024, the entire content of which is incorporated herein by reference as if set forth fully herein.

### FIELD

The present disclosure relates to the field of communication systems, and more particularly, to a base station antenna, as well as a radiating element and a phase shifter assembly for the base station antenna.

### BACKGROUND

Wireless base stations are well known in the art, and generally include baseband units, radios, antennas and other components. Antennas are configured to provide bidirectional radio frequency communication with fixed and mobile subscribers (“users”) located throughout the cell. Generally, antennas are installed on towers or raised structures such as poles, roofs, water towers, etc., and separate baseband units and radio equipment are connected to the antennas.

FIG. 1 is a schematic structural diagram of a conventional base station 10. The base station 10 comprises a base station antenna 15 that is capable of being mounted on an antenna tower 14. The base station 10 further comprises a baseband unit 11 and a radio unit 12. In order to simplify the attached drawing, a single baseband unit 11 and a single radio unit 12 are shown in FIG. 1. However, it should be understood that more than one baseband unit 11 and/or radio unit 12 may be provided. In addition, although the radio unit 12 is shown as being located at the same position as the baseband unit 11 at the bottom of the antenna tower 14, it should be understood that in other cases, the radio unit 12 may be a remote radio head (RRH) mounted on the antenna tower 14 adjacent to the base station antenna 15. The baseband unit 11 is capable of receiving data from another source (e.g., a backhaul network [not shown]), and is capable of processing the data and providing a data stream to the radio unit 12. The radio unit 12 is capable of generating radio frequency signals including data encoded therein and is capable of amplifying and transmitting these radio frequency signals to the base station antenna 15 through a radio frequency cable 13 (e.g., a coaxial transmission cable). It should also be understood that the base station 10 of FIG. 1 may generally include various other devices (not shown), such as a power supply, a backup battery, a power bus, an antenna interface signal group (AISG) controller, and the like. Generally, a base station antenna includes one or a plurality of phased arrays of radiating elements, wherein the radiating elements are arranged in one or a plurality of columns when the antenna is installed for use.

In order to transmit and receive radio frequency signals to and from the defined coverage area, the antenna beam generated by a radiating element array comprised in the base station antenna 15 is generally inclined at a certain downward angle with respect to the horizontal plane (referred to as a “downtilt”). In some cases, the downtilt of the antenna beam is generated electrically by adjusting the relative phase of sub-components of radio frequency signals fed to each set of radiating elements in the array that generates the antenna beam. The amount of electric downtilt applied to the antenna beam generated by the radiating element array of the base station antenna 15 is capable of, in some cases, being adjusted from a remote location. When the base station antenna 15 has such an electrical tilting capability, the physical orientation of the base station antenna 15 may remain fixed, but the effective inclination angle of the generated antenna beam (e.g., the peak of the antenna beam relative to the directional angle of the horizontal plane) may still be electrically adjustable, such as by controlling a phase shifter that adjusts the relative phase of sub-components of radio frequency signals provided to each radiating element in the array comprised in the base station antenna 15. The phase shifter and other related circuits are generally built in the base station antenna 15 and are capable of being controlled from a remote location. Typically, an AISG control signal is used to control the phase shifter.

Each phase shifter and power divider is generally constructed together as part of a feed network of the base station antenna 15 that feeds radio frequency signals received from the radio unit 12 to the radiating element array comprised in the base station antenna 15. The power divider divides the radio frequency signals input to the feed network into a plurality of sub-components, and the phase shifter applies an adjustable phase shift to each sub-component individually so that each sub-component is fed to the corresponding sub-array of one or a plurality of radiating elements. Many different types of phase shifters are known in the art, including rotary wiper arm phase shifters, cavity phase shifters, trombone style phase shifters, sliding dielectric phase shifters, and sliding metal phase shifters. For a base station antenna with an antenna array comprising a large number of radiating elements, using a cavity phase shifter is capable of achieving a simpler circuit structure and mechanical structure as compared to using a rotary wiper arm phase shifter.

### SUMMARY

A brief overview of the present disclosure is given below in order to provide a basic understanding of some aspects of the present disclosure. However, it should be understood that this overview is not an exhaustive overview of the present disclosure. It is not intended to be used to determine a critical or important part of the present disclosure, nor is it intended to be used to define the scope of the present disclosure. The purpose is merely to provide certain concepts of the present disclosure in simplified form as a preamble to the more detailed description provided later.

According to a first aspect of the present disclosure, a base station antenna is provided, comprising: a radiating element comprising a feed stalk and a radiator mounted on the feed stalk; a phase shifter assembly comprising a phase shifter cavity being disposed with through holes corresponding to the feed stalk on a wall proximate to the feed stalk; and a phase shift circuit mounted within the phase shifter cavity, wherein the feed stalk is configured to be fixed relative to the phase shift circuit and a first conductor feature of the feed stalk is directly electrically connected to a second conductor feature of the phase shift circuit by passing through the through holes.

According to a second aspect of the present disclosure, a radiating element for a base station antenna is provided, wherein the base station antenna is the base station antenna according to the first aspect of the present disclosure, and the radiating element comprises a feed stalk and a radiator mounted on the feed stalk.

According to a third aspect of the present disclosure, a phase shifter assembly for a base station antenna is provided, wherein the base station antenna is the base station antenna according to the first aspect of the present disclosure and the phase shifter assembly comprises a phase shifter cavity being disposed with through holes corresponding to the feed stalk on a wall proximate to the feed stalk; and a phase shift circuit mounted within the phase shifter cavity.

An advantage of the examples of the present disclosure is that the radiating element is directly electrically connected to the phase shifter assembly by employing one or more locking methods, which reduces or avoids the use of large amounts of phase cables, thereby simplifying the assemblies and structure of the base station antenna, and facilitating increased phase-shift accuracy of the base station antenna.

It should be appreciated that the above advantage does not need to be achieved in one or some particular examples, but may be partially dispersed in different examples according to the present disclosure. The examples according to the present disclosure may have one or some of the above advantages, and may alternatively or additionally have other advantages.

### BRIEF DESCRIPTION OF THE DRAWING

FIG. 1 shows a structural schematic diagram of a conventional base station.

FIGS. 2A to 2B show schematic diagrams of a base station antenna according to an example of the present disclosure, wherein FIG. 2A is a front perspective view of the base station antenna and FIG. 2B is a bottom view of the base station antenna.

FIG. 3A shows a structural schematic diagram of a phase shifter cavity of a phase shifter assembly in a base station antenna according to an example of the present disclosure.

FIG. 3B shows a structural schematic diagram of a feed stalk for a radiating element in a base station antenna according to an example of the present disclosure.

FIG. 3C shows a structural schematic diagram of a circuit board for a phase shift circuit mounted within a phase shifter cavity according to an example of the present disclosure.

FIGS. 3D and 3E show a front perspective view and a top view of the direct electrical connection between the feed stalk shown in FIG. 3B and the phase shift circuit shown in FIG. 3C.

FIG. 4 shows a schematic diagram of the feed stalk shown in FIG. 3B fixed to the phase shift circuit shown in FIG. 3C according to an example of the present disclosure.

FIG. 5A shows a structural schematic diagram of a feed stalk for a radiating element in a base station antenna according to another example of the present disclosure.

FIG. 5B shows a structural schematic diagram of a circuit board for a phase shift circuit mounted within a phase shifter cavity according to another example of the present disclosure.

FIG. 5C shows a front perspective view of the direct electrical connection between the feed stalk shown in FIG. 5A and the phase shift circuit shown in FIG. 5B.

FIG. 6A shows a structural schematic diagram of a feed stalk for a radiating element in a base station antenna according to an example of the present disclosure.

FIG. 6B shows a structural schematic diagram of a circuit board for a phase shift circuit mounted within a phase shifter cavity according to an example of the present disclosure.

FIG. 6C shows a top view of the direct electrical connection between the feed stalk shown in FIG. 6A and the phase shift circuit shown in FIG. 6B.

FIG. 7A shows a front perspective view of a feed stalk coupled to a phase shifter cavity via a substrate according to an example of the present disclosure.

FIG. 7B shows a bottom perspective view of a feed stalk coupled to a substrate according to an example of the present disclosure.

It should be noted that in the embodiments described below, the same reference signs are sometimes used across different attached drawings to denote the same parts or parts with similar functions, and repeated descriptions thereof are omitted. In some cases, similar labels and letters are used to denote similar items. Therefore, once an item is defined in one attached drawing, there is no need for further discussion in subsequent attached drawings.

For case of understanding, the position, dimension, and range of each structure shown in the attached drawings and the like sometimes do not represent the actual position, dimension, and range. Therefore, the present disclosure is not limited to the positions, dimensions, and ranges disclosed in the attached drawings and the like.

### DETAILED DESCRIPTION

Various exemplary examples of the present disclosure will be described in detail below by referencing the attached drawings. It should be noted: unless otherwise specifically stated, the relative arrangement, numerical expressions and numerical values of components and steps set forth in these examples do not limit the scope of the present disclosure.

The following description of at least one exemplary example is actually only illustrative, and in no way serves as any limitation to the present disclosure and its application or use. In other words, the structure and method herein are shown in an exemplary manner to illustrate different examples of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those skilled in the art may not be discussed in detail, but where appropriate, the technologies, methods, and equipment should be regarded as part of the Specification.

In all examples shown and discussed herein, any specific value should be construed as merely exemplary value and not as limiting value. Therefore, other examples of the exemplary example may have different values.

It should be noted that, when a plurality of the same or similar elements are provided herein, two-part numeral reference signs (e.g., first cavity 122-1, second cavity 122-2 and the like) may be used to label them in the attached drawings. These elements may be referred to herein individually by their respective full reference signs; and may be referred to collectively by a first part common in their reference signs (e.g., the phase shifter cavity 122) when no distinction is needed between them.

In current base station antennas, a feed board printed circuit board is generally disposed between the phase shifter and the radiating element. The surface of the feed board printed circuit board proximate to the radiating element is printed with a transmission line configured for feeding the radiating element to electrically connect an output end of the radiating element to the feed board printed circuit board, and the output end of the phase shifter is connected to the feed board printed circuit board via a phase cable. The electrical connection between the radiating element and the phase shifter is achieved via the feed board printed circuit board. In addition, an array formed by a plurality of radiating elements is generally disposed in the base station antenna considering the gain and communication capabilities of the base station antenna. Therefore, in a base station antenna, a large number of phase cables are generally used to achieve the connection between various radiating elements in the array and the phase shift circuit.

In terms of the performance of the base station antenna, the length of the phase cables increases the transmission distance of signals from the radiating element to the phase shifter, increases the signal transmission loss, and each phase cable has associated signal insertion losses that reduce the gain of the base station antenna. In addition, the size (e.g., length and width) of the phase cable may also affect the phase adjustment accuracy of the phase shifter. Further, for example, when soldering is employed, the presence of a large number of phase cables inevitably results in more solder joints between the radiating element and the output end of the phase shifter, thereby affecting the passive intermodulation performance of the entire phase shifter. In terms of manufacturing and assembly of the base station antenna, due to the limited area of the base station antenna, the radiating elements in the array are arranged in a compact manner, which tends to cause confusion and errors when connecting the radiating element and the phase shifter through a large number of phase cables, making the normal operation of the phase shifter and base station antenna impossible. In addition, the presence of a large number of phase cables is also detrimental to the automated assembly of the base station antenna, while the use of manual assembly would be very labor-and time-intensive. Therefore, a new base station antenna is desirable.

To this end, the present disclosure provides a base station antenna, which by introducing conductor features at corresponding locations of the radiating element and the phase shifter assembly, causes the feed stalk printed circuit board in the radiating element to be in direct electrical connection with the phase shift circuit of the phase shifter assembly, removing the feed board printed circuit board and/or phase cables in the conventional base station antenna, thereby reducing the transmission distance of signals from the radiating element to the phase shifter, reducing signal transmission losses, improving the phase adjustment accuracy of the phase shifter, ensuring the passive intermodulation performance of the phase shifter and gain of the base station antenna, and reducing the manufacturing cost of the base station antenna. Further, the removal of the phase cables also facilitates the automated assembly of the base station antenna and reduces manufacturing and assembly costs. In addition, the base station antenna of the present disclosure may also introduce fixing features to meet the specific polarization direction needs of the radiator in the radiating element and enhance the direct electrical connection between the radiating element and the phase shifter, reduce the process difficulty of direct electrical connection between the radiating element and the phase shifter, and further improve the performance of the base station antenna to improve the communication quality.

The examples of the present disclosure will now be described in further detail with reference to the attached drawings. It should be understood that the actual base station antenna, radiating element, and phase shifter assembly may further comprise other components, but to avoid obscuring the key elements of the present disclosure, they will not be discussed in the present disclosure and these other components will also not be shown in the attached drawings. In addition, for brevity, only one of the similar or the same components may be marked in the drawings.

It should be understood that the relationship between the mounting of the feed stalk and the radiator causes the number of feed stalks to have a linear relationship with the number of the radiators. In addition, as the feed stalk printed circuit board is electrically connected to the radiator, and the feed stalk printed circuit board is electrically connected to the phase shift circuit such that the radiator is electrically connected to the phase shift circuit, the radio frequency signals transmitted and received by the radiator may be transmitted via the feed stalk to the phase shift circuit. Therefore, in the present disclosure, the direct electrical connection between the feed stalk and the phase shift circuit also means that the radiating element is in direct electrical connection with the phase shifter assembly. It should be understood that “direct electrical connection” in the present disclosure refers to electrical connection not made via additional external conductive structures such as feed board printed circuit boards, phase cables, and the like, including but not limited to fixing the relative position of the feed stalk to the phase shift circuit by way of mechanical means to ensure coupling between the radiating element and the phase shifter assembly.

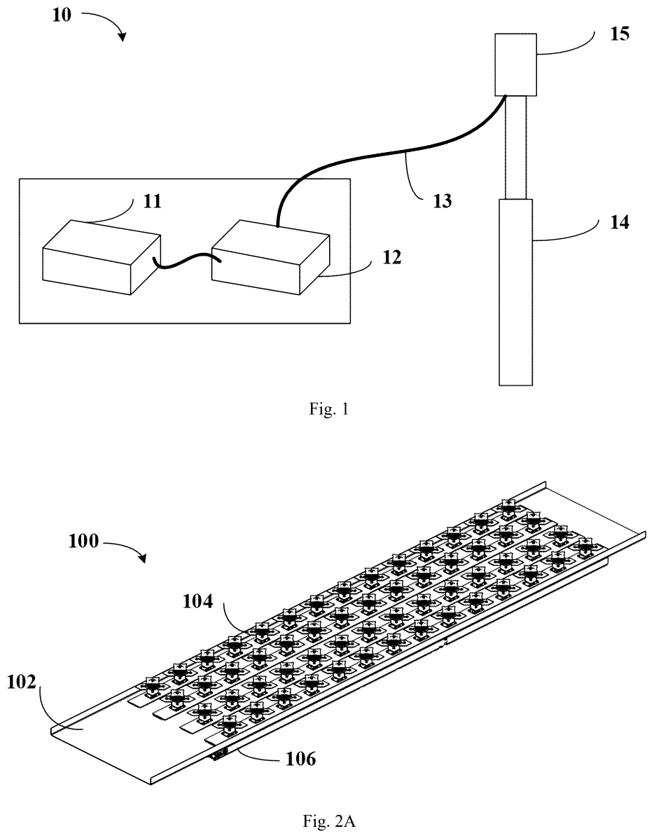

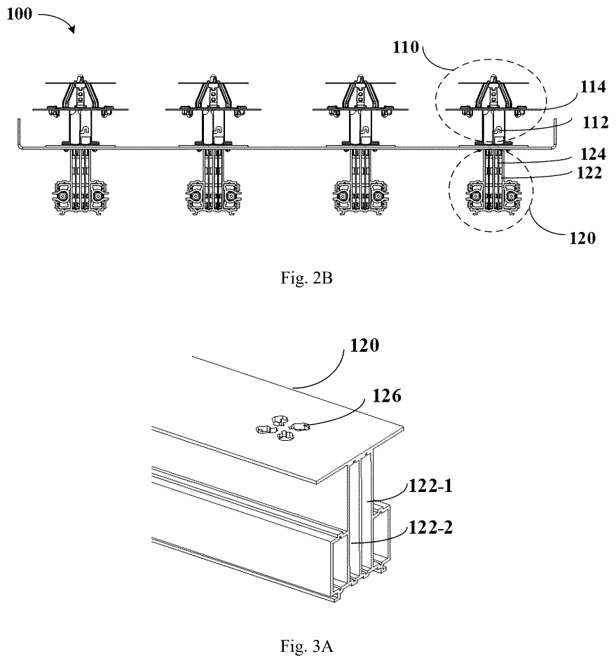

Now, referring to FIGS. 2A to 2B, FIGS. 2A to 2B show schematic diagrams of a base station antenna 100 according to some examples of the present disclosure, wherein FIG. 2A is a front perspective view of the base station antenna and FIG. 2B is a bottom view of the base station antenna. As shown in FIGS. 2A and 2B, the base station antenna 100 comprises radiating elements 110. wherein the radiating elements 110 comprise a feed stalk 112 and a radiator 114 mounted on the feed stalk 112. Unless otherwise specified, “radiating elements” herein refer to the radiating elements 110 including a radiator 114 and a supporting element/feed stalk 112 for the radiating elements 110. Unless otherwise specified, “radiator” herein refers to a radiator comprising one or a plurality of dipoles (although other types of radiating elements such as patch radiating elements are sometimes used), such as the radiator 114 that comprises two dipoles that are orthogonal to each other as shown in FIGS. 2A and 2B. “Feed stalk” herein may refer to a feed stalk 112 that provides feeding and support to the radiator 114 or to a feed stalk printed circuit board having conductive traces thereon. It should be understood that, for brevity of description, the feed stalk printed circuit board may also sometimes refer directly to the feed stalk, i.e., the two are not differentiated in description unless otherwise specified.

Further, the base station antenna 100 further comprises phase shifter assemblies 120, wherein the phase shifter assemblies 120 comprise a phase shifter cavity 122 and a phase shift circuit 124 mounted within the phase shifter cavity 122. Lines are laid on the phase shift circuit 124 through both the top (Top) and bottom (Bot) layers of the phase shifter assemblies 120, and electrical signals are transmitted between the lines on the Top and Bot layers via a metalized through-hole connection. In addition, as also shown in FIGS. 2A and 2B, the base station antenna 100 may also comprise a reflector 102, an array 104 comprising a plurality of radiating elements 110 mounted in a column on one side of the reflector 102, and a feed network 106 comprising phase shifter assemblies 120 mounted on the other side of the reflector 102, wherein the reflector 102 may be used as the ground plane of the array 104. The reflector 102 may be constructed of conductive materials such as copper, aluminum, or the like, to reinforce the radiation of the array 104 in the upper half space and to inhibit radiation within the lower half space.

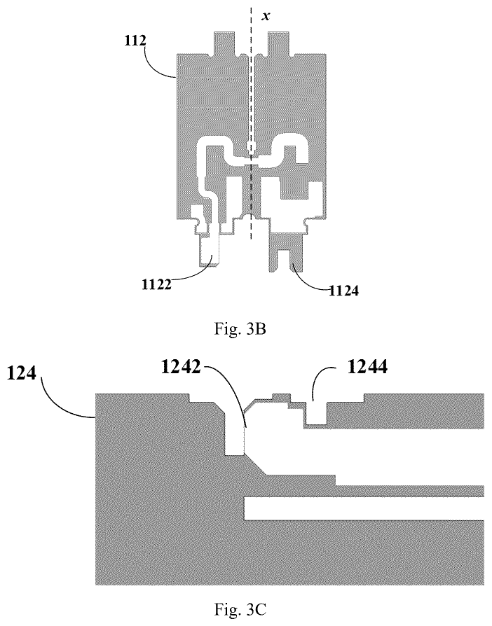

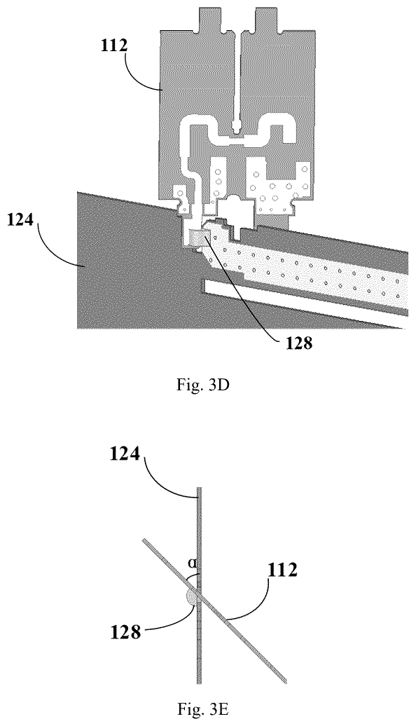

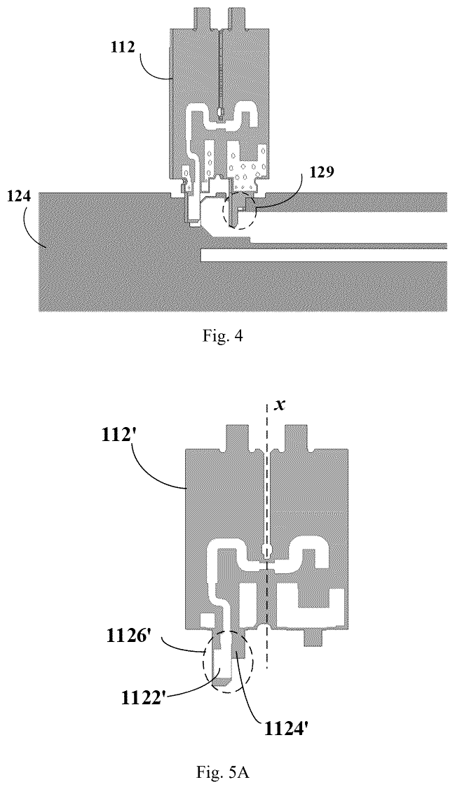

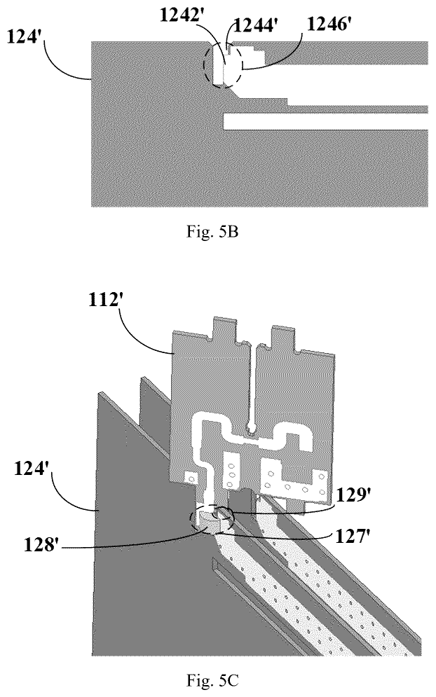

With reference to FIG. 3A, FIG. 3A shows a structural schematic diagram of a phase shifter cavity of a phase shifter assembly in a base station antenna according to an example of the present disclosure, wherein only the frame part at one end of the phase shifter cavity is shown schematically, omitting other components such as the phase shift circuit and the power divider circuit mounted in the cavity. As shown in the drawing, through holes 126 corresponding to the feed stalk 112 are disposed on the wall of the phase shifter cavity 122 proximate to the feed stalk 112, i.e., the feed stalk 112 is mounted to a fixed position with respect to the phase shifter assembly via the through holes 126 and thereby achieves connection with the internal circuitry of the phase shifter cavity 122. It should be understood that the through holes shown in FIG. 3A are merely exemplary and non-limiting and do not represent the actual configuration of the through holes 126 on the phase shifter cavity 112 in the base station antenna. Those skilled in the art may configure the location, number, size, shape, and the like of the through holes 126 according to the specific structure of the feed stalk 112 and actual assembly requirements.

Next, refer to FIG. 3B, which shows a structural schematic diagram of a feed stalk for a radiating element in a base station antenna according to an example of the present disclosure. It should be understood that the feed stalk of the radiating element may comprise a single feed stalk printed circuit board or may have a pair of feed stalk printed circuit boards, with FIG. 3B illustrating the situation of the former. As shown in FIG. 3B, it should be understood that the feed stalk 112 of the base station antenna may generally be considered substantially symmetrical relative to the axis x. The feed stalk 112 forms a first conductor feature 1122 with the foot on one side of the axis x to electrically connect the feed stalk 112 and the phase shift circuit 124. Accordingly, FIG. 3C shows a structural schematic diagram of a circuit board mounted within the phase shifter cavity for a phase shift circuit according to an example of the present disclosure, the phase shift circuit 124 having a second conductor feature 1242 corresponding to the first conductor feature of the feed stalk 112.

Further referring to FIGS. 3D and 3E, a front perspective view and a top view of the direct electrical connection between the feed stalk shown in FIG. 3B and the phase shift circuit shown in FIG. 3C are shown, respectively. In particular, the first conductor feature 1122 of the feed stalk 112 and the second conductor feature 1242 of the phase shift circuit 124 within the phase shifter cavity 122 achieve direct electrical connection, and in conjunction with the foregoing FIG. 3A, the feed stalk 112 needs to pass a foot formed with the first conductor feature 1122 through the through holes 126 on the phase shifter cavity 122 to enter the interior of the phase shifter cavity 122 to be configured to be fixed relative to the phase shift circuit 124. In other words, the direct electrical connection between the feed stalk 112 and the phase shift circuit 124 not only provides a transmission channel where signals are transmitted from the radiating element 110 to the phase shifter 120, but also ensures a relatively fixed positional relationship between the feed stalk 112 and the phase shift circuit 124. Alternatively, other components and/or other methods may be used to ensure that the feed stalk 112 is fixed relative to the phase shift circuit 124, such as the fixing features and/or the substrate to be described below.

In some examples, the direct electrical connection between the feed stalk 112 and the phase shift circuit 124 is achieved by soldering the first conductor feature 1122 of the feed stalk 112 to the second conductor feature 1242 of the phase shift circuit 124. For example, as shown in FIGS. 3D and 3E, the first conductor feature 1122 of the feed stalk 112 is soldered to the second conductor feature 1242 of the phase shift circuit 124, thereby forming a solder joint 128 such that the feed stalk 112 is in direct electrical connection with the phase shift circuit 124. It should be understood that other components of the base station antenna are omitted for purposes of highlighting the connection portions in the foregoing attached drawings, and the schematic diagram of the electrical connection between the feed stalk 112 and the phase shift circuit 124 shown in the present disclosure is for the purpose of schematically describing their relative positional relationship when the feed stalk 112 is to be electrically connected to the phase shift circuit 124 and does not represent the actual situation of the electrical connection between the feed stalk 112 and the phase shift circuit 124 in the base station antenna 100. In actual application, the feed stalk 112 and phase shift circuit 124 may be connected through a mechanical connection or contain other components or structures, such as the foregoing wall of the phase shifter cavity 122 proximate to the feed stalk 112 being located between the feed stalk 112 and the phase shift circuit 124.

Additionally, returning to FIG. 2A, in some examples, in order to form a balanced radiation pattern, the dipoles in the radiator 114 often need to be configured to transmit and receive radio frequency signals in a specific polarization direction at a certain angle relative to the longitudinal axis of the array 104. In the base station antenna 100, the dipoles in the radiator 114 are coupled with the feed stalk 112 to define the polarization direction of the dipoles, the angle between the feed stalk 112 and the longitudinal axis of the array 104 and the angle between the dipoles and the longitudinal axis of the array 104 have a corresponding relationship (such as substantially the same or different fixed angle), and the direction of extension of the phase shift circuit 124 is parallel to the longitudinal axis of the array 104. Generally, the feed stalk 112 is configured in a polarization direction to obtain better isolation degree and polarization purity, i.e., to facilitate cross-polarization inhibition. Therefore, the polarization direction of the dipoles may be mapped based on the angle between the feed stalk 112 and the phase shift circuit 124. In a non-limiting example, when a dipole in one direction of the radiator 114 is configured to be arranged in the direction of the feed stalk 112, the feed stalk 112 is correspondingly configured to employ the feed stalk printed circuit board at an angle to the phase shift circuit 124 in order for the dipole of the radiator 114 to transmit and receive radio frequency signals in the desired polarization direction a. It should be understood that the placement angle of the feed stalk 112 and the phase shift circuit 124 may be disposed based on the needs of the actual application and is not limited to the same polarization direction as the dipole supported.

Further, as shown in FIG. 3E, the process of achieving direct electrical connection (i.e., achieving the solder joint 128) between the first conductor feature 1122 and the second conductor feature 1242 based solely on the two is very challenging where the angle a between the feed stalk 112 and the phase shift circuit 124 does not align or does not align approximately perpendicularly/parallel to each other. Therefore, to reduce process difficulties, to ensure that the feed stalk 112 is fixed relative to the phase shift circuit 124 to enhance the reliability of the direct electrical connection between the feed stalk 112 and the phase shift circuit 124, optionally, the feed stalk 112 also has a first fixing feature 1124 for fixing the feed stalk 112 to the phase shift circuit 124, and accordingly, the phase shift circuit 124 also has a second fixing feature 1244 corresponding to the first fixing feature 1124 of the feed stalk 112, wherein the first fixing feature 1124 of the feed stalk 112 is locked to the second fixing feature 1244 of the phase shift circuit 124 by passing through the through holes 126 on the phase shifter cavity 122. For example, as shown in FIG. 4, a first fixing feature 1124 of the feed stalk 112 enters the interior of the phase shifter cavity 122 by passing through the through holes 126 (not shown) and is locked with the second fixing feature 1244 of the phase shift circuit 124 to form a locking portion 129. It should be understood that the locking of the first fixing feature 1124 and the second fixing feature 1244 may be formed by one or more of shape locking (e.g., snap-fitting), material locking (e.g., fasteners), force locking (e.g., bonding), and other means of connection that may achieve an effective fixing relationship.

In some examples, as shown in FIG. 3B, the first conductor feature 1122 and the first fixing feature 1124 of the feed stalk 112 are formed separate from one another, i.e., the first conductor feature 1122 and the first fixing feature 1124 are formed at the feet of both sides of the axis x of the feed stalk 112, respectively. In some other examples, as shown in FIG. 5A, the first conductor feature 1122′ and the first fixing feature 1124′ of the feed stalk 112′ may be formed in an abutting manner to one another, i.e., the first conductor feature 1122′ and the first fixing feature 1124′ are formed at the foot of the same side of the axis x of the feed stalk 112′. It should be understood that in this example, the combination 1126′ of the first conductor feature 1122′ and the first fixing feature 1124′ may also be considered as having provided a fixing feature of the feed stalk 112′ relative to the phase shift circuit 124′. Accordingly, in this example, as shown in FIG. 5B, the second conductor feature 1242′ and the second fixing feature 1244′ of the phase shift circuit 124′ are also formed in an abutting manner to one other to correspond to the first conductor feature 1122′ and the first fixing feature 1124′ of the feed stalk 112′. In addition, the combination 1246′ of the second conductor feature 1242′ and the second fixing feature 1244′ may also be considered a fixing feature of the phase shift circuit 124′ corresponding to the feed stalk 112′.

Refer to FIG. 5C, which shows a front perspective view of the direct electrical connection between the feed stalk shown in FIG. 5A and the phase shift circuit shown in FIG. 5B, wherein the first conductor feature 1122′ of the feed stalk 112′ and the second conductor feature 1242′ of the phase shift circuit 124′ pass through, for example, a solder joint 128′ formed by soldering to achieve a direct electrical connection between the feed stalk 112′ and the phase shift circuit 124′. Additionally, the first fixing feature 1124′ of the feed stalk 112′ is locked with the second fixing feature 1244′ of the phase shift circuit 124′ to form a locking portion 129′, thereby ensuring that the feed stalk 112′ is fixed relative to the phase shift circuit 124′. Alternatively, the fixing feature 1126′ of the feed stalk 112′ is locked with the fixing feature 1246′ of the phase shift circuit 124′ to form a combined locking portion 127′ to ensure that the feed stalk 112′ is fixed relative to the phase shift circuit 124′.

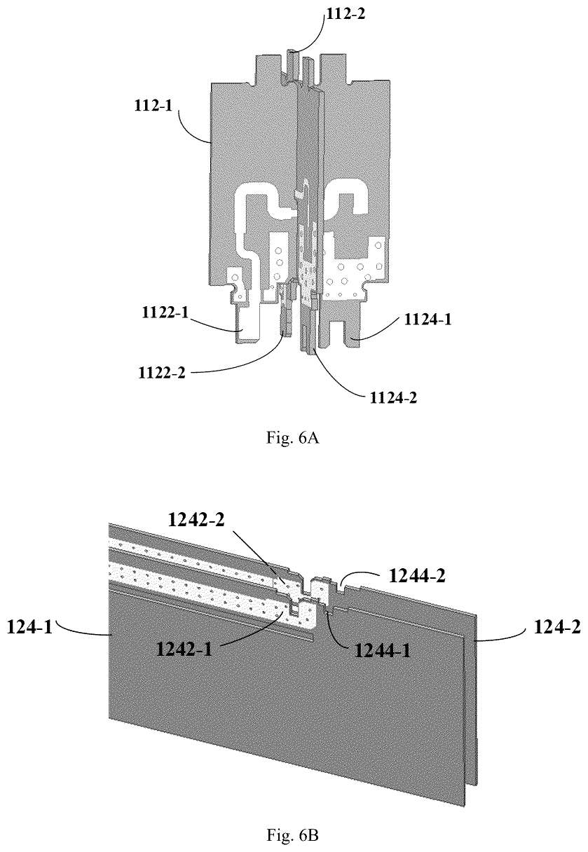

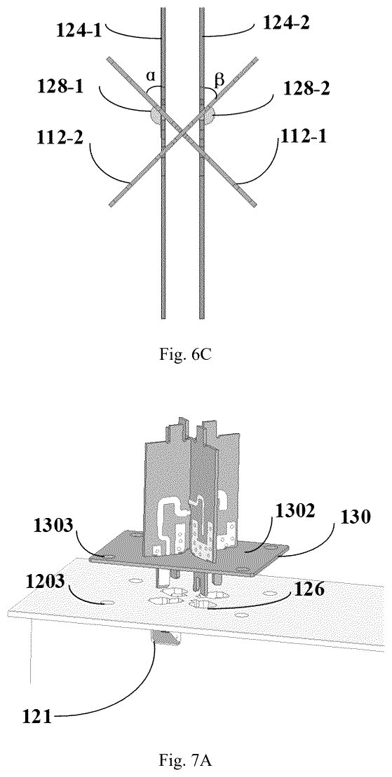

Additionally, in some examples, the radiating element 110 in the base station antenna 100 employs a cross dipole radiator that comprises a first dipole and a second dipole that cross each other, wherein the first dipole in the cross dipole radiator is configured to transmit and receive radio frequency signals in a first polarization direction a and the second dipole is configured to transmit and receive radio frequency signals in a second polarization direction β. Optionally, the first dipole and second dipole may also be configured to transmit and receive radio frequency signals in an orthogonal polarization manner. For example, one of the first dipole and second dipole is configured to transmit and receive radio frequency signals in the first polarization direction that is −45° relative to the longitudinal axis of the array 104, while the other of the first dipole and second dipole is configured to transmit and receive radio frequency signals in the second polarization direction that is +45° relative to the longitudinal axis of the linear array. Corresponding to the first dipole and second dipole (not shown) that are orthogonal to each other, as shown in FIG. 6A, the radiating element 112 also comprises two orthogonal feed stalks 112-1 and 112-2, wherein the first dipole is mounted on the first feed stalk 112-1 and the second dipole is mounted on the second feed stalk 112-2. Accordingly, as shown in FIG. 3A, the phase shifter cavity 122 is formed as a first cavity 122-1 corresponding to the first dipole and a second cavity 122-2 corresponding to the second dipole. Further, as shown in FIG. 6B, a first phase shift circuit 124-1 is mounted in the first cavity 122-1 and a second phase shift circuit 124-2 is mounted in the second cavity 122-2.

As shown in FIGS. 6A-6C, in some examples, the first conductor feature 1122-1 of the first feed stalk 112-1 is in direct electrical connection (e.g., by forming a solder joint 128-1 by soldering) with the second conductor feature 1242-1 of the first phase shift circuit 124-1 by passing through the corresponding through holes 126 (not shown) on the phase shifter cavity 122. Moreover, the first fixing feature 1124-1 of the first feed stalk 112-1 is fixed to the second phase shift circuit 124-2 via the second fixing feature 1244-2 of the second phase shift circuit 124-2 by passing through the through holes 126, wherein the first feed stalk 112-1 forms an angle a with the first phase shift circuit 124-1 to meet the polarization direction requirements of the first dipole. In particular, in the event that a is not equal to or approximately equal to 90°/180°, the soldering operation between the first conductor feature 1122-1 and the second conductor feature 1242-1 thereby becomes easy based on the locking relationship between the first fixing feature 1124-1 and the second fixing feature 1244-2.

Continuing to refer to FIGS. 6A-6C, in some examples, the first conductor feature 1122-1 of the first feed stalk 112-1 is in direct electrical connection with the second conductor feature 1242-1 of the first phase shift circuit 124-1 by passing through the through holes 126 on the phase shifter cavity 122; and the first fixing feature 1124-1 of the first feed stalk 112-1 is fixed to the second phase shift circuit 124-2 via the second fixing feature 1244-2 of the second phase shift circuit 124-2 by passing through the corresponding through hole in the through holes 126, wherein the first feed stalk 112-1 may, for example, form an angle a with the first phase shift circuit 124-1 to meet the polarization direction requirements of the first dipole. At the same time, the first conductor feature 1122-2 of the second feed stalk 112-2 is in direct electrical connection with the second conductor feature 1242-2 of the second phase shift circuit 124-2 by passing through the through holes 126; and the first fixing feature 1124-2 of the second feed stalk 112-2 is fixed to the first phase shift circuit 124-1 via the second fixing feature 1244-1 of the first phase shift circuit 124-1 by passing through the corresponding through hole in the through holes 126, wherein the second feed stalk 112-2 may, for example, form an angle β with the second phase shift circuit 124-2 to meet the polarization direction requirements of the second dipole.

Additionally, or alternatively, in some other examples, the electrical connection between the foregoing first conductor feature 1122-1 and the second conductor feature 1242-1, and the electrical connection between the first conductor feature 1122-2 and the second conductor feature 1242-2 are capable of achieving one or both, and optionally, additionally achieve one or both of the locking and fixing of the first fixing feature 1124-1 and the second fixing feature 1244-2, and the locking and fixing of the first fixing feature 1124-2 and the second fixing feature 1244-1, and the specific choice thereof may be set based on the actual application scenario. It should be understood that the second conductor features 1242-1 and 1242-2 shown in FIG. 6B are located on one side of the corresponding phase shift circuit 124, respectively, and are connected to a line on the other side of the corresponding phase shift circuit 124 through metalized through holes. As can be seen in conjunction with FIG. 6C, the second conductor feature 1242-2 that is disposed symmetrically to the first conductor feature 1242-1 is located on the outer side of the phase shift circuit 124-1 (i.e., located on the back side of the second phase shift circuit 124-2 of FIG. 6B) away from the phase shift circuit 124-2, facilitating soldering operations between the feed stalk and the phase shift circuit.

It should be understood that those skilled in the art may reasonably configure the number of dipoles in the radiator according to the actual needs of the base station antenna, as well as set the conductor features and fixing features on the feed stalk and the phase shift circuit to select a specific electrical connection/fixing method between the feed stalk and phase shift circuit, thereby achieving direct electrical connection between the dipole and the phase shifter.

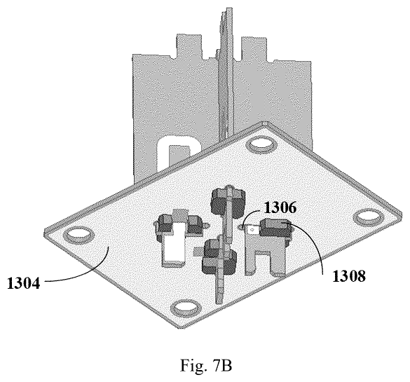

Next, refer to FIGS. 7A and 7B, which show a front perspective view of a feed stalk coupled to a phase shifter cavity via a substrate, and a bottom perspective view of a feed stalk coupled to a substrate, respectively, according to an example of the present disclosure. Generally, in a base station antenna, the phase shifter cavity 122 of the phase shifter 120 is configured to be grounded to achieve efficient transmission of radio frequency signals within the cavity. As previously noted, the reflector 102 may be used as a ground plane of the array 104. Therefore, in some examples, the phase shifter cavity 122 may be configured to couple with the reflector 102 to be grounded together. It should be understood that the phase shifter cavity 122 may also be grounded in other suitable ways, such as configured to be grounded directly, and the like.

As described in the foregoing examples, when the first conductor feature 1122 of the feed stalk 112 is in direct electrical connection with the second conductor feature 1242 of the phase shift circuit 124 by passing through the through holes 126 on the phase shifter cavity 122, the feed stalk 112 is in electrical connection with the phase shifter cavity 122 such that the radiating elements 110 are grounded together with the phase shifter cavity 122 via the feed stalk 112. It should be understood that to achieve direct electrical connection between the feed stalk 112 and the phase shift circuit 124 in the interior of the phase shifter cavity 122 by passing through the through holes 126, the first conductor feature 1122 is disposed on the foot of the feed stalk 112 for mounting to the phase shifter cavity 122 in the form of conductive traces and the like, which causes the grounding area of the feed stalk 112 to be reduced, affecting the grounding stability of the printed circuit board thereon.

As such, in some examples, as shown in FIGS. 7A-7B, to further enhance the electrical connection between the feed stalk 112 and the phase shifter cavity 122, the base station 100 may further comprise a substrate 130 mounted between the feed stalk 112 and the phase shifter cavity 122, wherein the surface of the substrate 130 proximate to the side of the phase shifter cavity 122 is disposed with a coupling face 1304 for direct electrical connection with the phase shifter cavity 122. For example, the coupling face 1304 of the substrate 130 may be a conductive layer covering the entire surface of the substrate 130 proximate to the side of the phase shifter cavity 122 to increase the grounding area; and the disposition of the substrate 130 also facilitates the reduction of manufacturing costs compared to having to dispose conductive traces on the feed board printed circuit board. Optionally, the surface 1302 of the substrate 130 proximate to the side of the radiating element 110 covers an insulating layer to avoid generating spurious electrical signals that interfere with the normal operation of the base station antenna. Further, in this example, continuing to refer to FIG. 7B, the substrate 130 is further disposed with a grounding through hole 1306 corresponding to the feed stalk 112, wherein the feed stalk 112 is electrically connected to the substrate 130 by passing through the grounding through hole 1306 on the substrate 130, and the coupling face 1304 of the substrate 130 is directly coupled to the surface of the phase shifter cavity 122 proximate to the side of the feed stalk 112, such that the radiating element 110 is grounded together with the phase shifter cavity 122 via the feed stalk 112 and substrate 130, ensuring that the radiating element 110 is grounded. The electrical connection between the feed stalk 112 and the substrate 130 by passing through the grounding through hole 1306 may be achieved by way of soldering (solder joint 1308), such as that shown in FIG. 7B. Additionally, one or a plurality of fixing holes (as shown by circular holes 1303 in FIG. 7A) are disposed on the substrate 130 to fix the substrate 130 to a corresponding position (circular holes 1203 as shown in FIG. 7A) of the phase shifter cavity 122 via one or a plurality of mechanical structures, so as to ensure the stability of the electrical coupling between the coupling face 1304 and the phase shifter cavity 122, thereby facilitating assurance of the effect of the radiating element 110 being grounded together with the phase shifter cavity 122.

Returning to FIG. 7A, an assembly through hole 121 is also disposed on the sidewalls of the phase shifter cavity 122. As shown in FIG. 7A, where the feed stalk 112 needs to pass through the grounding through hole 1306 on the substrate 130 and pass through the through holes 126 on the phase shifter cavity 122 into the phase shifter cavity 122, the feed stalk 112 is fixed relative to the substrate 130 firstly based on the grounding through hole 1306 and circular holes 1303 on the substrate 130 and the circular holes 1203 on the phase shifter cavity 122, then the combination of the feed stalk 112 and the substrate 130 is fixed relative to the phase shifter cavity 122 based on the through holes 126 on the phase shifter cavity 122. Therefore, the first conductor feature 1122 and/or the first fixing feature 1124 of the feed stalk 112 and the second conductor feature 1242 and/or second fixing feature 1244 of the phase shift circuit 124 are in positions that are capable of achieving the direct electrical connection described in the foregoing examples. At this point, the feed stalk 112 is soldered to the substrate 130, and the feed stalk 112 is soldered to the phase shift circuit 124 via the assembly through hole 121 on the sidewall of the phase shifter cavity 122, such as by processes such as soldering, thereby achieving grounding of the radiating element 110 together with the phase shifter assemblies 120 and direct electrical connection between the feed stalk 112 and the phase shift circuit. Alternatively, the connection of the feed stalk 112 to the substrate 130 may be completed prior to assembly to the phase shifter cavity 122, with soldering operation of the feed stalk 112 to the phase shift circuit 124 being achieved only via the assembly through hole 121.

The present disclosure also provides radiating elements for a base station antenna, wherein the base station antenna corresponding to the radiating elements may be the base station antenna 100 in any of the foregoing examples, and the radiating elements may comprise a feed stalk and a radiator mounted on the feed stalk. For example, still referring to FIG. 2B, the radiating elements 110 for the base station antenna 100 may comprise the feed stalk 112 and the radiator 114 mounted on the feed stalk 112. The various examples of the radiating elements 110 may refer to the previous description of the various examples of the base station antenna 100, which will not be repeated herein.

The present disclosure also provides a phase shifter assembly for a base station antenna, wherein the base station antenna corresponding to the phase shifter assembly may be the base station antenna 100 in any of the foregoing examples, the phase shifter assembly may comprise a phase shifter cavity and a phase shift circuit mounted within the phase shifter cavity being disposed with through holes corresponding to the feed stalk on the wall proximate to the feed stalk. For example, still referring to FIG. 2B, the phase shifter assembly for the base station antenna 100 may comprise the phase shifter cavity 122 and the phase shift circuit 124 mounted within the phase shifter cavity. The various examples of the phase shifter assemblies 120 may refer to the previous description of the various examples of the base station antenna 100, which will not be repeated herein.

The terms “left”, “right”, “front”, “rear”, “top”, “bottom”, “upper”, “lower”, “high”, “low” in the Specification and Claims, if present, are used for descriptive purposes and not necessarily used to describe constant relative positions. It should be understood that the terms used in this way are interchangeable under appropriate circumstances, so that the examples of the present disclosure described herein, for example, can operate on other orientations that differ from those orientations shown herein or otherwise described. For example, when the device in the drawing is turned upside down, features that were originally described as “above” other features can now be described as “below” other features. The device may also be oriented by other means (rotated by 90 degrees or at other locations), and at this time, a relative spatial relation will be explained accordingly.

In the Specification and Claims, when an element is referred to as being “above” another element, “attached” to another element, “connected” to another element, “coupled” to another element, or “contacting” another element, the element may be directly above another element, directly attached to another element, directly connected to another element, directly coupled to another element, or directly contacting another element, or there may be one or a plurality of intermediate elements. In contrast, if an element is described “directly” “above” another element, “directly attached” to another element, “directly connected” to another element, “directly coupled” to another element or “directly contacting” another element, there will be no intermediate elements. In the descriptions and claims, a feature that is arranged “adjacent” to another feature, may denote that a feature has a part that overlaps an adjacent feature or a part located above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “basically” means comprising any minor changes caused by design or manufacturing defects, device or component tolerances, environmental influences, and/or other factors. The word “basically” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “include/comprise” is used in this text, it indicates the presence of the specified feature, entirety, step, operation, unit and/or component, but does not exclude the presence or addition of one or more other features, entireties, steps, operations, units and/or components and/or combinations thereof.

In the present disclosure, the term “provide” is used in a broad sense to cover all ways of obtaining an object, so “providing an object” includes but is not limited to “purchase”, “preparation/manufacturing”, “arrangement/setting”, “installation/assembly”, and/or “order” of the object, etc.

As used herein, the term “and/or” includes any and all combinations of one or more of the associated listed items. The terms used herein are only for the purpose of describing specific examples, and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed in the additional operation, and the operations can be executed at least partially overlapping in time. Also, alternative examples may include a plurality of instances of specific operations, and the order of operations may be changed in other various examples. However, other modifications, changes and substitutions are also possible. Aspects and elements of all examples disclosed above may be combined in any manner and/or in conjunction with aspects or elements of other examples to provide a plurality of additional examples. Therefore, the Specification and attached drawings hereof should be regarded as illustrative rather than limitative.

Although some specific examples of the present disclosure have been described in detail through examples, those skilled in the art should understand that the above examples are only for illustration rather than for limiting the scope of the present disclosure. The examples disclosed herein can be combined arbitrarily without departing from the spirit and scope of the present disclosure. Those skilled in the art should also understand that various modifications may be made to the examples without departing from the scope and spirit of the present disclosure. The scope of the present disclosure is defined by the attached claims.

That which is claimed is:

1. A base station antenna, comprising:
a radiating element comprising a feed stalk and a radiator mounted on the feed stalk;
a phase shifter assembly, comprising
a phase shifter cavity being disposed with through holes corresponding to the feed stalk on a wall proximate to the feed stalk; and
a phase shift circuit mounted within the phase shifter cavity,
wherein the feed stalk is configured to be fixed relative to the phase shift circuit and a first conductor feature of the feed stalk is directly electrically connected to a second conductor feature of the phase shift circuit by passing through the through holes.

2. The base station antenna according to claim 1, wherein
the feed stalk also has a first fixing feature for fixing the feed stalk to the phase shift circuit;
the phase shift circuit also has a second fixing feature corresponding to the first fixing feature for fixing the feed stalk,
wherein the first fixing feature is locked to the second fixing feature by passing through the through holes.

3. The base station antenna according to claim 2, wherein
the first conductor feature and the first fixing feature are formed in an abutting manner to one another on the feed stalk.

4. The base station antenna according to claim 1, the radiator comprises a first dipole and a second dipole that cross each other, wherein the first dipole is configured to transmit and receive radio frequency signals in a first polarization direction and the second dipole is configured to transmit and receive radio frequency signals in a second polarization direction.

5. The base station antenna according to claim 4, wherein the phase shifter cavity forms a first cavity corresponding to the first dipole and a second cavity corresponding to the second dipole, wherein the first cavity and second cavity are respectively mounted with a first phase shift circuit and a second phase shift circuit within.

6. The base station antenna according to claim 5, wherein:
the first dipole is mounted on a first feed stalk and the first conductor feature of the first feed stalk is in direct electrical connection with the second conductor feature of the first phase shift circuit by passing through the through holes; and
the first fixing feature of the first feed stalk is fixed to the second phase shift circuit via the second fixing feature of the second phase shift circuit by passing through the through holes.

7. The base station antenna according to claim 5, wherein
the first dipole is mounted on a first feed stalk and the first conductor feature of the first feed stalk is in direct electrical connection with the second conductor feature of the first phase shift circuit by passing through the through holes; and
the second dipole is mounted on the second feed stalk, and the first conductor feature of the second feed stalk is in direct electrical connection with the second conductor feature of the second phase shift circuit by passing through the through holes.

8. The base station antenna according to claim 7, wherein
the first fixing feature of the second feed stalk is fixed to the first phase shift circuit via the first fixing feature of the first phase shift circuit by passing through the through holes.

9. The base station antenna according to claim 1, wherein the phase shifter cavity is grounded and the feed stalk is electronically connected to the phase shifter cavity such that the radiating element is grounded together with the phase shifter cavity via the feed stalk.

10. The base station antenna according to claim 1, wherein the base station antenna further comprises
a substrate mounted between the feed stalk and the phase shifter cavity,
wherein the surface of the substrate proximate to the side of the phase shifter cavity is disposed with a coupling face for direct electrical connection with the phase shifter cavity.

11. The base station antenna according to claim 10, wherein
the substrate is further disposed with a grounding through hole corresponding to the feed stalk,
wherein the feed stalk is electrically connected to the substrate by passing through the grounding through hole, such that the radiating element is grounded together with the phase shifter cavity via the feed stalk and the substrate.

12. A radiating element for a base station antenna, wherein the base station antenna is the base station antenna according to claim 1, the radiating element comprising a feed stalk and a radiator mounted on the feed stalk.

13. A phase shifter assembly for a base station antenna, wherein the base station antenna is the base station antenna according to claim 1, the phase shifter assembly comprising
a phase shifter cavity being disposed with through holes corresponding to the feed stalk on a wall proximate to the feed stalk; and
a phase shift circuit mounted within the phase shifter cavity.
